(19) United States
(12) Patent Application Publication
(10) Pub. No.: US 2022/0274357 A1
(43) Pub. Date: Sep. 1, 2022

(54) Method for Producing a Fiber-Reinforced Plastic Component and Fiber-Reinforced Component

(71) Applicant: Bayerische Motoren Werke Aktiengesellschaft, Muenchen (DE)

(72) Inventors: Mirko SCHADE, Landshut (DE); Bernhard ZEILMEIER, Geisenhausen (DE)

(21) Appl. No.: 17/631,827

(22) PCT Filed: Jun. 10, 2020
(86) PCT No.: PCT/EP2020/066089

§ 371 Date: Jan. 31, 2022

(30) Foreign Application Priority Data
Aug. 1, 2019 (DE) 10 2019 120 810.6

(51) Int. Cl. B29C 70/68; B32B 5/02; B29C 70/48

(52) U.S. Cl. CPC B29C 70/682; B32B 5/026; B29C 70/48; B32B 2307/718; B32B 2307/402; B32B 2605/00; B29L 2031/3005

(57) ABSTRACT

A method for producing a fiber-reinforced plastic component and a fiber-reinforced plastic component. The method includes providing a textile insert having a decoration, inserting the textile insert and a semi-finished fiber product into a pressing tool, and processing the textile insert, the semi-finished fiber product, and a matrix material in the pressing tool to form the fiber-reinforced plastic component. The matrix material is cured during the processing.

### BACKGROUND AND SUMMARY OF THE INVENTION

The invention relates to a method for producing a fiber-reinforced plastic component and fiber-reinforced component.

Within the context of lightweight construction, fiber-reinforced plastic components are increasingly being used in vehicle bodies. These usually have a matrix material of plastic in which a fiber reinforcement is embedded in order to achieve the necessary strength and mechanical characteristics. The fiber reinforcement can be formed from one or more layers of reinforcing fibers, which are present as woven fabrics, laid fabrics, mesh or in another form. The production of such fiber-reinforced plastic components is carried out, for example, in the resin-transfer molding (RTM) process or by wet pressing.

If components are to be produced with a carbon fiber visual appearance, then use is usually made of a matrix material which cures transparently and through which the uppermost fiber layer (then typically a carbon fiber mesh or woven fabric) remains visible.

Further color design options are desirable during the production of such plastic components. For vehicle components, in particular high requirements are placed on the contours of the decorations, the color brilliance, the color depth and the UV resistance.

Against this background, the object of the present invention is to specify a possible way how a fiber-reinforced plastic component decorated with a decoration can be produced in mass production; in particular it should be possible to produce a component in visible carbon fiber optics. Furthermore, the intention is to specify a plastic component which is decorated with a decoration and which satisfies the visual requirements in automobile construction.

A method for producing a fiber-reinforced plastic component is specified, for which a semi-finished fiber product forming the fiber reinforcement is processed together with a matrix material in a pressing tool and is cured to form the plastic component.

According to the invention, a textile insert provided with the decoration is inserted into the pressing tool in addition to the semi-finished fiber product and integrated into the matrix material by the pressing operation.

Also specified is a fiber-reinforced plastic component which includes a fiber reinforcement that is embedded in a matrix material, and a textile insert provided with a decoration. The textile insert is arranged on the fiber reinforcement and embedded in the matrix material.

The fiber-reinforced plastic component can in particular be a vehicle component, for example a body component or attachment. It can in particular be produced by the method described and therefore includes the same technical effects and advantages.

The semi-finished fiber product includes at least one layer of reinforcing fibers such as, for example, carbon fibers, glass fibers or aramid fibers. The semi-finished fiber product is preferably present as a stack formed of multiple layers of reinforcing fibers. The reinforcing fibers are preferably aligned unidirectionally or bidirectionally. The semi-finished fiber product can be present, for example, as a flat, preferably pre-shaped, semi-finished product or, for example, be arranged around a supporting core. The semi-finished fiber product preferably includes a carbon woven fabric.

The textile insert can be, for example, a laid fabric, woven fabric or nonwoven. In a preferred refinement, the textile insert is a knitted material, in particular a knitted fabric. A knitted material is a two-dimensional structure which is produced from one or more threads or from one or more thread systems by knitting. In knitted materials, one thread loop is looped into another. To produce a knitted fabric, the thread forms stitches on top of each other, i.e., the thread runs vertically and forms a wale with the adjacent thread, while one stitch is produced beside the other during knitting, the thread thus running horizontally. The meshes present create interspaces between the fiber strands. These fill with matrix material and form a multiplicity of “tunnels”, by which the material lying underneath is attached. As compared with a woven fabric or nonwoven, knitted material of the same weight forms a considerably higher permeability for matrix material. In each case there are tunnel-like cavities between the meshes, through which the matrix material can flow relatively freely; as a result, despite the elasticity of the knitted material, slipping or distortion of the insert during the infiltration process is prevented. In addition, the use of knitted fabric achieves a particular depth of color. As a result of the tunnel-like mesh interspaces, the structure of the fiber reinforcement that lies underneath can show through. The human eye combines the color appearance of the pattern with the structural appearance of the interspaces, so that the pattern in the finished component appears as if it were printed directly on the fiber reinforcement.

The textile insert is not restricted to specific materials and can be produced, for example, from natural or synthetic fibers. Preferably, the textile insert has polyester fibers; the textile insert is preferably formed of polyester. Polyester exhibits good thermal resistance to high temperatures, as can occur during the further processing, for example in the RTM process. The naturally colorless and naturally cloudy polyester fibers have a good dye absorption capacity; high color saturation can be achieved by dyeing. Furthermore, during the production of the plastic component, they suck up the matrix material completely. The polyester fibers exhibit the advantageous property that they become (approximately) transparent (“wet effect”). As a result, polyester fibers impregnated with resin remain milkily translucent and the fiber reinforcement located behind the insert becomes partly visible.

The textile insert is provided with a decoration. The decoration can be, for example, a pattern, text or a trademark. The decoration can extend over the entire insert or only part of the insert.

The insert printed with the decoration can be designed in white, black or in one or more other colors. The insert can be configured to be single-colored or multicolored. The insert can be produced, for example, from colored fibers. The insert can likewise be produced as a textile and then be provided with an imprint. Direct printing methods are particularly suitable as a printing method. During direct printing, individual ink droplets are applied directly via a print head to the substrate to be printed. A wide range of colors and a high resolution of the printed decoration can be implemented. Following the application, the printed textile is heated, the ink dries or hardens.

Particularly preferably, the insert is printed by latex printing. Here, a latex ink is used and applied. The latex ink contains virtually no volatile compounds such as, for example, solvents. Very good UV stability of the color on the textile can be achieved by latex printing. As a result of the input of heat within the context of the method, a stable and UV-resistant connection to the semi-finished textile product is achieved. It is also advantageous that the latex ink penetrates easily into the fibers of the textile and does not lie on the textile as a barrier film. The textile structure is largely maintained and is thus accessible to the following infiltration with matrix material. If the textile is additionally also formed as a knitted fabric, then the knitted material presents only a low flow resistance to the matrix material. The matrix material can flow around the meshes through the cavities and surround them on all sides.

In order to achieve a visually satisfactory Class A surface and at the same time a brilliant color depth and saturation, it has proven to be advantageous if the textile insert has a weight in the range from 50 g/m² to 150 g/m². A polyester knitted fabric of this weight additionally has the advantage that it can be introduced into the molding tool without any tool change or process adaptation being required.

A polyester knitted fabric with a weight of less than or up to 110 g/m² is usually used primarily as a flag material. In flag printing, the use of latex printing is rather unusual, since a lower color intensity can be achieved with this printing method as compared with other printing methods. In addition, the latex ink lies on or slightly in the fiber, which leads to undesired fiber breakage during handling of the printed textile. Surprisingly, however, it has been shown that this stress whitening vanishes following the resin injection and that a polyester knitted fabric of such a fine weight, if it is printed with latex printing and processed as an insert in the plastic component, nevertheless exhibits high color brilliance and has a very high UV resistance.

To produce the fiber reinforced plastic component, the textile insert and the semi-finished fiber product are inserted into the cavity of a pressing tool. There, the two semi-finished products, together with a matrix material, are pressed into the shape of the component to be produced and the matrix material is hardened.

The method can be an injection method such as, for example, the resin transfer molding (RTM) process. In the RTM process, the semi-finished fiber product is inserted into the tool cavity, the tool is closed and the uncured matrix material is injected into the cavity under pressure. The matrix material infiltrates the semi-finished fiber product and hardens.

In an alternative refinement, the plastic component is produced by wet pressing. For this purpose, the semi-finished fiber product is provided with the matrix material even before the pressing tool is closed. During the closing operation, the previously added matrix material is distributed over the tool cavity and wets the fibers of the semi-finished fiber product.

The textile insert can be inserted into the tool independently of the semi-finished fiber product or together with the semi-finished fiber product. If the textile insert is introduced together with the semi-finished fiber product, then it is preferably fixed to the latter, for example by an adhesive or stitching. In this way, slipping of the insert during the insertion and the subsequent pressing is prevented. If the component is produced in the wet pressing method, then instead of a separate fixing agent, the applied matrix material can also serve to fix the textile insert to the semi-finished fiber product.

Because of the high injection pressures and wide flow paths of the matrix material in the RTM process, in one refinement it is advantageous if the textile insert is fixed relative to the tool. For this purpose, the textile insert can, for example, reach over the entire length or width of the cavity and be positioned and fixed in the edge region by means of a clamping device.

In order that the decoration of the insert is subsequently visible, the textile insert is preferably inserted into the tool in such a way that it forms the visible side in the finished component, that is to say, viewed from the visible side, the textile insert forms the uppermost fiber layer in the finished component. In other words, the textile insert is preferably arranged on a side of the fiber reinforcement that faces the visible side of the component.

The matrix material used is preferably a reactive resin system which, in addition to the resin and a hardener, can contain still further ingredients. Preferably, the plastic compound also contains an internal release agent. The matrix material is, for example, a transparently hardening resin system, wherein the addition of colorants is also conceivable, depending on the desired appearance of the component.

As a result of the advantages outlined previously, the method is particularly suitable for producing components in mass production processes up to a large series and therefore for the vehicle industry. In the case of components with a visible carbon fiber look, it is possible to produce an appearance as if it were processed without a textile insert. In a particularly preferred refinement, a vehicle component such as, for example, a body component or body attachment is produced by the method.

Further advantages, features and details of the invention emerge from the following description in which, with reference to the drawings, exemplary embodiments of the invention are described in detail. Here, the features mentioned in the claims and in the description can each be important to the invention on their own or in any desired combination. If, in this application, the term “can” is used, this concerns both the technical possibility and also the actual technical implementation.

Exemplary embodiments will be explained below by using the appended drawings.

### BRIEF DESCRIPTION OF THE DRAWINGS

FIG. 1 shows a schematic illustration of an example of a method sequence;

FIG. 2A shows a sectional view of a vehicle component; and

FIG. 2B shows a plan view of the vehicle component from FIG. 2A.

### DETAILED DESCRIPTION OF THE DRAWINGS

In the method, firstly a textile insert 1 is provided. The insert 1 is designed to be colored, for example with a decoration 2, lettering here. The decoration 2 can be, for example, a brand emblem or the like. The decoration 2 can extend over the entire insert 1 or only part of the insert. The textile insert 1 is preferably a polyester knitted material having a weight in the range from 50 g/m² to 150 g/m². The colored design of the insert 1 is preferably made by latex printing with suitable colors.

The textile insert 1, together with a semi-finished fiber product 8 and a matrix material 9, is further processed in a temperature-controlled pressing tool 3. The pressing tool 3 includes a cavity, which depicts the outer contour of the fiber-reinforced plastic component to be produced. The cavity is delimited by the inner wall 4, 5 of the tool parts 6 and 7.

The method is preferably carried out as an RTM process. To this end, firstly the textile insert 1 and the semi-finished fiber product 8 are inserted into the cavity of the tool. The semi-finished fiber product 1 forms the subsequent fiber reinforcement in the component. The textile insert 1 makes no noticeable contribution to the strength of the component.

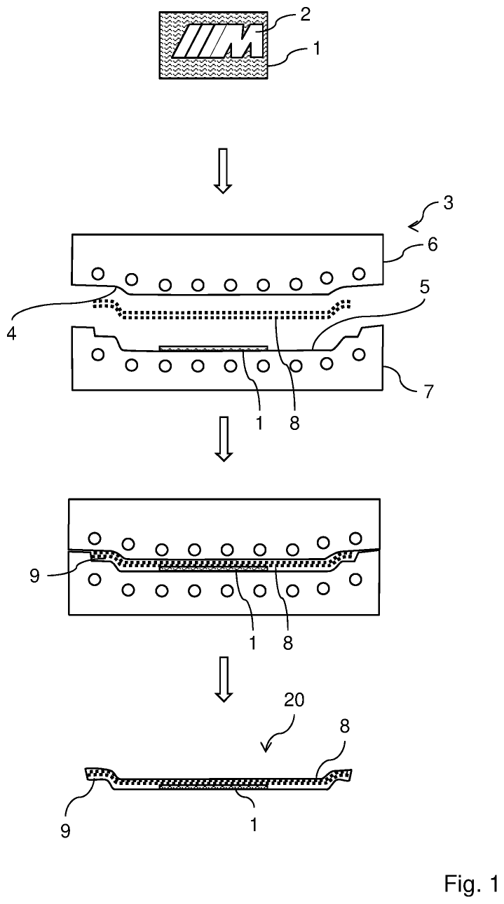

The textile insert 1 can be inserted into the tool 3, for example independently of the semi-finished product 8, as shown in FIG. 1. The textile insert 1 is then preferably fixed relative to the tool 3. If the textile insert 1 reaches over the entire width or length of the component, then it can be clamped and positioned on the tool, for example by means of a clamping device.

The textile insert 1 can also be positioned first on the semi-finished fiber product 8 and fixed, for example with an adhesive or stitched, and then introduced into the pressing tool 3 together with the semi-finished fiber product 8.

The tool 3 is closed and a curable matrix material 9, for example an epoxy resin provided with hardener, is injected into the closed tool 3 under pressure by means of a filling system, not illustrated. In the tool, the plastic compound impregnates the semi-finished fiber product 8 and the textile insert 1.

Alternatively, the plastic component 20 can also be produced in the wet pressing method. Then, the semi-finished fiber product 8 is not only wetted with matrix material 9 in the tool 3, instead the matrix material is already applied to the semi-finished fiber product 8 when the latter is inserted into the pressing tool 3. For the production in the wet pressing method, it is advantageous if the textile insert 1 is first fixed to the semi-finished fiber product. This can be done without any additional fixing agent because of the matrix material that is already present. Alternatively, the textile insert can also be positioned directly in the tool.

The decoration 2 on the textile insert 1 is intended to be visible in the finished plastic component 20. Therefore, in the pressing tool 3, it is preferably placed in such a way that the insert having the decoration 2 is arranged on the subsequent visible side of the component.

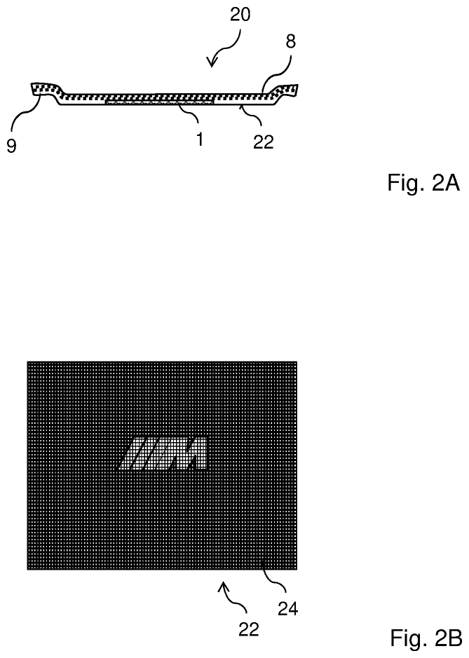

FIG. 2A shows a sectional view through a plastic component 20 which has been produced by the method according to FIG. 1. The plastic component 20 is a vehicle component such as, for example, a vehicle roof or another body component (attachment). The plastic component 20 contains the fiber reinforcement 8 incorporated in the matrix material 9, which is preferably formed from multiple layers of carbon fiber fabric. Since a transparently curing resin system is used as the matrix material 9, the carbon structure remains visible in the finished plastic component 20. On the visible side 22 of the plastic component 20, the textile insert 1 is incorporated into the plastic matrix 9. Here, the polyester fibers not printed with the decoration 2 have remained milkily cloudy under the influence of the resin system. The carbon structure 24 located underneath continues to be visible. The carbon structure can also be detected in the region of the decoration since, because of the material and printing method used, the mesh interspaces are not filled with color and allow the fabric structure lying underneath still to show through. FIG. 2B shows a plan view of the visible side 22 of the plastic component 20.

The size and shape of the insert can vary in order to depict different decorations or produce effects. For example, the insert can reach as a strip over the entire component width or length or it is possible to use an insert which covers the semi-finished fiber product 8 over the entire component.

### LIST OF REFERENCE CHARACTERS

1 Textile insert
2 Decoration
3 Pressing tool
4,5 Inner wall
6,7 Tool parts
8 Semi-finished fiber product
9 Matrix material
20 Fiber-reinforced component
22 Visible side
24 Carbon fiber structure

1.-14. (canceled)

15. A method for producing a fiber-reinforced plastic component, comprising the acts of:
providing a textile insert having a decoration;
inserting the textile insert and a semi-finished fiber product into a pressing tool; and
processing the textile insert, the semi-finished fiber product, and a matrix material in the pressing tool to form the fiber-reinforced plastic component, wherein the matrix material is cured during the processing.

16. The method according to claim 15, wherein the textile insert is a knitted material.

17. The method according to claim 15, wherein the textile insert has a weight in a range from 50 g/m² to 150 g/m² or in the range from 50 g/m² to 110 g/m².

18. The method according to claim 15, wherein the textile insert is colored.

19. The method according to claim 15, wherein the textile insert is printed by latex printing.

20. The method according to claim 15, wherein the producing of the fiber-reinforced plastic component is carried out in a resin-transfer molding (RTM) process.

21. The method according to claim 15, wherein the producing of the fiber-reinforced plastic component is carried out by wet pressing.

22. The method according to claim 15, wherein the textile insert is positioned and fixed on the semi-finished fiber product or the textile insert is positioned and fixed in the pressing tool.

23. A fiber-reinforced plastic component, comprising:
a fiber reinforcement which is embedded in a matrix material; and
a textile insert that has a decoration, wherein the textile insert is disposed on the fiber reinforcement and is embedded in the matrix material.

24. The fiber-reinforced plastic component according to claim 23, wherein the textile insert is a knitted material.

25. The fiber-reinforced plastic component according to claim 23, wherein the textile insert in a dry state has a weight in a range from 50 g/m² to 150 g/m² or in the range from 50 g/m² to 110 g/m².

26. The fiber-reinforced plastic component according to claim 23, wherein the textile insert is colored.

27. The fiber-reinforced plastic component according to claim 23, wherein the textile insert is printed by latex printing.

28. The fiber-reinforced plastic component according to claim 23, wherein the textile insert is disposed on a side of the fiber reimbursement that faces a visible side of the fiber-reinforced plastic component.
